(19) United States
(12) Patent Application Publication
(10) Pub. No.: US 2017/0174281 A1
(43) Pub. Date: Jun. 22, 2017

(54) CLOSURE SYSTEM FOR FLEXIBLE BAG

(71) Applicant: Christopher C. Boyd, Lafayette, CO (US)

(72) Inventor: Christopher C. Boyd, Lafayette, CO (US)

(21) Appl. No.: 15/380,454

(22) Filed: Dec. 15, 2016

Related U.S. Application Data
(60) Provisional application No. 62/268,375, filed on Dec. 16, 2015.

(51) Int. Cl. B62J 9/00; B65D 33/16

(52) U.S. Cl. CPC B62J 9/003; B65D 33/16

(57) ABSTRACT

The present disclosure relates to a closure system for a flexible container. The closure system generally includes a flexible member and a substantially rigid member. The flexible and rigid members are each interconnected to opposing portions of an aperture of the container. When the closure system is in a closed state, the flexible member is in a position proximate to the rigid member. The flexible member may be pulled away from the rigid member to move the closure system to an open state. The closure system will remain in the open or closed state without contact from the user. The user may return the closure system to the closed state by applying a predetermined force to the flexible member.

### CROSS-REFERENCE TO RELATED APPLICATIONS

This application claims the benefit of priority under 35 U.S.C. §119(e) to U.S. Provisional Patent Application Ser. No. 62/268,375, filed Dec. 16, 2015 which is incorporated herein by reference in its entirety.

### FIELD

The present disclosure relates to a closure system comprising a flexible member and a substantially rigid member. The flexible and rigid members are each interconnected to opposing portions of an aperture, such as for a flexible bag. When the closure system is in a closed state, the flexible member is in a position proximate to the rigid member. The flexible member may be pulled away from the rigid member to move the closure system to an open state. The closure system will remain in the open or closed state without contact from the user. The user may return the closure system to the closed state by applying a predetermine force to the flexible member.

### BACKGROUND

Flexible containers and bags are very useful. They are generally inexpensive, lightweight, and can be compressed to a small size. Accordingly, flexible bags are useful in a variety of applications. Unfortunately, because bags have flexible bodies, the opening may not stay open or closed when desired. A user may have to continuously grasp a portion of the bag to keep the aperture open. In some situations, this may not be possible and, in some applications, may be dangerous. For example, storage bags with flexible bodies are frequently interconnected to a portion of a vehicle, such as a bicycle frame. But it is difficult to load items into, or retrieve items from, the storage bag with only one hand. Thus, it is frequently challenging to load items into a storage bag while operating a vehicle in a safe manner, for instance, while keeping at least one hand on the handlebars of a moving bicycle. In some situations, the cyclist may become distracted while attempting to load objects in the bag, which may be dangerous or decrease the performance of the cyclist.

Some closure systems have been adapted for flexible containers and bags. However, known closure systems for flexible bags generally require the user to continuously apply a force to the closure system to keep the aperture of the bag open.

Accordingly, there is an unmet need for a closure system for a flexible bag that provides improved access to the interior of the bag without a continuous force applied by a user and that remains open until the user applies a predetermined closing force.

### SUMMARY

The present disclosure provides a novel closure system for a flexible bag. One aspect of the present disclosure is to provide a closure system that stays open or closed until a predetermined force is applied by a user.

Another aspect of the present disclosure is a closure system for a flexible container that is adapted to transition from an open state to a closed state upon receiving a minimal amount of force from a user.

Yet another aspect of the present disclosure is a flexible container adapted to be releasably interconnected to a vehicle. The flexible container includes a closure system adapted to retain an aperture of the container in either an open or closed position without sustained contact from a user. The flexible container includes a body of any size or shape. The container body includes a plurality of connection elements to releasably interconnect the container to the vehicle. The closure system enables a user to add or remove objects from an interior of the container without the user holding the aperture of the container open. In one embodiment, the vehicle comprises a two-wheeled vehicle, such as a bicycle or a motorcycle.

It is another aspect of the present disclosure to provide a novel closure system for a flexible container. The closure system generally comprises, but is not limited to: (1) a flexible member interconnected to a first portion of the flexible container proximate to an aperture of the container; and (2) a substantially rigid member interconnected to a second portion of the container proximate to the aperture, the second portion in a substantially opposing alignment with the first portion. When the closure system is in a closed state, the flexible member is in a position proximate to the rigid member. The flexible member may be pulled away from the rigid member to place the closure system in an open state. The closure system will remain in the open state without contact from the user. The user may return the closure system to the closed state by applying a predetermine force to the flexible member.

The flexible container may have any size or shape and may be made of any suitable material. In one embodiment, the flexible container has a width of between about 5 inches and about 9.5 inches. Additionally, or alternatively, the flexible container may have a height of between about 4 inches and about 8.5 inches. Optionally, when the closure system is in an open state, the container aperture has a width of between about 2 inches and about 6.5 inches. In one embodiment, the flexible container is made of one or more materials including fabric, leather, plastic, and paper. In one embodiment, the flexible container is a bag.

The flexible container may be adapted to be interconnected to a portion of an object. In one embodiment, the objection comprises a bicycle and the portion of the bicycle comprises the handlebar and the stem (or the stem extension) of the handlebar. Accordingly, one or more loops may be interconnected to a portion of the container to interconnect the flexible container to the handlebar. In one embodiment, the positions of the loops may be moved by the user. In another embodiment a first flexible container is adapted to be interconnected to a first side of the handlebars of the bicycle. A second flexible container is adapted to be interconnected to a second side of the handlebars in an opposing relationship to the first flexible container. Loops interconnected to the first and second containers are positioned in a staggered arrangement such that the loops of the first container do not interfere with the loops of the second container. In one embodiment, two loops are positioned proximate to a first portion of the rigid member and two different loops are positioned proximate to a second portion of the rigid member.

The substantially rigid member may have any size or cross-section and may be made of any suitable material. In one embodiment, the substantially rigid member comprises one or more of metal, wood, plastic, and combinations thereof. In another embodiment, the substantially rigid member is made of a laminate material comprising one or more layers of at least one of metal, wood, and plastic. In one embodiment, the cross-section of the substantially rigid member provides some, or all, of the rigidity. In another embodiment, the material of the substantially rigid member provides some, or all, of the rigidity.

In one embodiment, the substantially rigid member is not linear. In another embodiment, the substantially rigid member comprises a first portion interconnected at a vertex to a second portion at an angle. The first and second portions are generally linear. In one embodiment, the angle between the first and second portions is between about 5° to about 175°. In another embodiment, the angle between the first and second portions is between about 70° and about 110°. In a more preferred embodiment, the angle is between about 85° and about 95°.

In yet another embodiment, the first and second portions are adjustably interconnected. Accordingly, the angle between the first and second portions may be adjusted by a user. For example, the first and second portions may be interconnected by a threaded fastener such as, but not limited to, a bolt or a screw. Accordingly, the user may loosen the threaded fastener to adjust the angle between the first and second portions.

The flexible member may be made of any suitable resilient material. In one embodiment, the flexible member is made from a plastic material, but other materials with suitable resilient properties may be used. For example, the flexible member may be made of a plastic, a metal, a wood, or any combination thereof. In one embodiment, the flexible member is made of a laminate material comprising a plurality of layers of at least one of a plastic, a metal, and a wood. Further, the flexible member may comprise one or more portions.

The flexible member may have any suitable cross-sectional shape. As can be appreciated by a skilled artisan, the flexible member may have a substantially planar cross-section. However, other shapes that are not planar are contemplated. For example, in one embodiment the flexible member may have a generally circular cross-section. In another embodiment, the cross-section of the flexible member varies in dimension and/or shape along a length of the flexible member.

In one embodiment, the first portion of the substantially rigid member may be interconnected to a first portion of the flexible member. Similarly, the second portion of the substantially rigid member may be interconnected to a second portion of the flexible member.

The flexible member has a length that is greater than a distance between ends of the substantially rigid member. In this manner, the flexible member is adapted to bend when the closure system is in the closed state such that the flexible member is generally proximate to the rigid member. When the closure system is in the open state, the flexible member bends away from the rigid member into a bowed or arcuate shape. Accordingly, at least a portion of the aperture of the container has a generally arcuate or bowed shape when the closure system is in the open state.

As will be appreciated, one or more handles or pulls may be interconnected to the flexible container. The handles or pulls can be in any variety of locations to facilitate actuation of the closure system by the user.

Additionally, or alternatively, the closure system may include fasteners. The fasteners may be selected to prevent inadvertent or unintended movement of the closure system from the closed state to the open state. The fasteners may comprise one or more of a latch, a magnet, a snap, and a lace.

Another aspect of the present invention is to provide a container with an aperture configured to remain in an open configuration without contact from a user. The container includes, but is not limited to: (1) a body portion with the aperture; (2) a flexible member interconnected to a first portion of the body portion; (3) an actuation member interconnected to the first portion of the body portion; and (4) a substantially rigid member interconnected to a second portion of the body portion; and at least two connection elements interconnected to the second portion of the body portion, wherein, when the flexible member is proximate to the substantially rigid member the aperture is in a closed configuration, and wherein, in the open configuration, at least a portion of the flexible member is separated from the rigid member. Pulling on the actuation member transitions the aperture from the closed configuration to the open configuration. In one embodiment, a force must be applied to the first portion in a direction toward the second portion to transition the aperture from the open configuration to the closed configuration. In another embodiment, the at least two connection elements are adapted to interconnect the container to a portion of a bicycle.

Optionally, the substantially rigid member may comprise a first portion interconnected to a second portion. In one embodiment, an angle between the first and second portions of the substantially rigid member is between about 70° and about 110°. Alternatively, in another embodiment, the first and second portions of the substantially rigid member are pivotally interconnected such that an angle between the first and second portions may be adjusted to be between about 70° and about 110°.

It is yet another aspect of the present invention to provide a method of making a container with an aperture configured to remain in an open configuration without contact from a user. The method comprises: (1) interconnecting a flexible member to a first portion of a flexible body of the container; (2) interconnecting a substantially rigid member to a second portion of the flexible body, wherein the second portion is in an opposing relationship to the first portion; (3) interconnecting at least two connection elements to the second portion of the flexible body, the at least two connection to releasably interconnect the container to a bicycle; and (4) interconnecting an actuation member to the first portion of the flexible body, wherein pulling on the actuation member transitions the aperture from the closed configuration to the open configuration. When the container aperture is in the closed configuration, the flexible member is in a position proximate to the substantially rigid member. In one embodiment, container aperture will remain in the open configuration without contact from the user. The container aperture may be returned to the closed configuration by applying a predetermine force to the flexible member.

In one embodiment, the connection elements comprise one or more loops. In another embodiment, two loops are positioned proximate to a first portion of the rigid member and two different loops are positioned proximate to a second portion of the rigid member.

In one embodiment, the substantially rigid member is not linear. In another embodiment, the substantially rigid member comprises a first portion interconnected at a vertex to a second portion at an angle. The first and second portions are generally linear. In one embodiment, the angle between the first and second portions is between about 5° to about 175°. In another embodiment, the angle between the first and second portions is between about 70° and about 110°. In a more preferred embodiment, the angle is between about 85° and about 95°.

In yet another embodiment, the first and second portions are adjustably interconnected. Accordingly, the angle between the first and second portions may be adjusted by a user. For example, the first and second portions may be interconnected by a threaded fastener such as, but not limited to, a bolt or a screw. Accordingly, the user may loosen the threaded fastener to adjust the angle between the first and second portions.

In one embodiment, the first portion of the substantially rigid member may be interconnected to a first portion of the flexible member. Similarly, the second portion of the substantially rigid member may be interconnected to a second portion of the flexible member.

The flexible member has a length that is greater than a distance between ends of the substantially rigid member. In this manner, the flexible member is adapted to bend when the container aperture is in the closed configuration such that the flexible member is generally proximate to the rigid member. When the container aperture is in the open configuration, the flexible member bends away from the rigid member into a bowed or arcuate shape. Accordingly, at least a portion of the container aperture has a generally arcuate or bowed shape when the container aperture is in the open configuration.

These and other advantages will be apparent from the disclosure contained herein. This Summary is neither intended nor should it be construed as being representative of the full extent and scope of the present disclosure. As will be appreciated, other embodiments of the disclosure are possible using, alone or in combination, one or more of the features set forth above or described in detail below. Moreover, references made herein to “the present invention,” “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detail Description, particularly when taken together with the drawings.

To provide additional background and context, and to further satisfy the written description requirements, the following patents are incorporated by reference in their entireties for the express purpose of explaining and further describing a variety of known and related closure systems: U.S. Pat. No. 1,224,842; U.S. Pat. No. 1,798,945; U.S. Pat. No. 3,272,248; U.S. Pat. No. 4,756,628; U.S. Pat. No. 4,898,477; U.S. Pat. No. 5,037,138; U.S. Pat. No. 5,184,896; U.S. Pat. No. 5,472,281; U.S. Pat. No. 6,022,144; U.S. Pat. No. 6,168,312; and U.S. Pat. No. 6,328,191.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

Although various dimensions are provided to illustrate exemplary embodiments of the present disclosure and the components thereof, it is expressly contemplated that dimensions may be modified in an apparatus of the present disclosure and still comport with the scope and spirit of the disclosure. Thus, unless otherwise indicated, all numbers expressing quantities, dimensions, conditions, and so forth used in the specification and claims are to be understood as being modified in all instances by the term “about.”

### BRIEF DESCRIPTION OF THE DRAWINGS

The accompanying drawings, which are incorporated in and constitute a part of the specification, illustrate embodiments of the disclosure and together with the general description of the disclosure given above and the detailed description given below, serve to explain the principles of this disclosure.

Throughout this disclosure, similar components and/or features may have the same reference number. Components of the same type may be distinguished by a letter following the reference number. If only the reference number is used, the description is applicable to any one of the similar components having the same reference number.

FIG. 1 is a perspective view of a container system including an embodiment of the closure system of the present disclosure interconnected to a flexible bag and with the closure system in a closed state;

FIG. 2 is a front elevation view of the container system of FIG. 1;

FIG. 3 is a top elevation view of the container system of FIG. 1;

FIG. 4 is a partial cross-sectional view of the container system of FIG. 1 taken along line 4-4 of FIG. 2 with the flexible bag removed to show the closure system in the closed state;

FIG. 5 is a top elevation view of the container system of FIG. 1 with the closure system positioning the closure aperture in an open state;

FIG. 6 is a partial cross-sectional view of the container system similar to FIG. 4 with the flexible bag removed to show the closure system in the open state;

FIGS. 7-8 are top elevation views of a closure system of another embodiment of the present disclosure in which an angle between a first and second portion of the substantially rigid member is not orthogonal and illustrating the closure system in each of a closed state and in an open state, respectively;

FIGS. 9-26 are photographs a flexible bag including a closure system according to another embodiment of the present disclosure;

FIG. 27 is a photograph of a container system interconnected to handlebars of a bicycle, the container system including a closure system according to still another embodiment of the present disclosure, illustrating the closure system in a closed state;

FIG. 28 is a photograph of the container system and closure system of FIG. 27 with the closure system in an open state; and

FIG. 29 is a top elevation view of two container systems of an embodiment of the present disclosure interconnected to a bicycle.

It should be understood that the drawings, photographs, and diagrams are not necessarily to scale. In certain instances, details which are not necessary for an understanding of the disclosure or which render other details difficult to perceive may have been omitted. It should be understood, of course, that the disclosure is not necessarily limited to the particular embodiments illustrated herein.

To assist in the understanding of one embodiment of the present invention the following list of components and associated numbering found in the drawings is provided herein:

| Number | Component |
|---|---|
| 2 | Container system |
| 4 | Flexible container |
| 5 | Container portions |
| 6 | Container aperture |
| 8 | Hem |
| 10 | Connection elements |
| 12 | First portion of connection element |
| 14 | Second portion of connection element |
| 16 | Actuation member |
| 20 | Closure system |
| 22 | Flexible member |
| 24 | First portion of flexible member |
| 26 | Second portion of flexible member |
| 28 | Third portion of flexible member |
| 30 | Substantially rigid member |
| 32 | First portion of rigid member |
| 34 | First end of rigid member |
| 36 | Second portion of rigid member |
| 38 | Second end of rigid member |
| 40 | Vertex |
| 42 | Closed state |
| 44 | Open state |
| 120 | Closure system |
| 122 | Flexible member |
| 130 | Substantially rigid member |
| 132 | First portion of rigid member |
| 136 | Second portion of rigid member |
| 140 | Vertex |
| 202 | Container system |
| 204 | Flexible container |
| 205 | Container portions |
| 206 | Container aperture |
| 210 | Connection elements |
| 216 | Actuation member |
| 220 | Closure system |
| 222 | Flexible member |
| 230 | Substantially rigid member |
| 234 | First end of rigid member |
| 238 | Second end of rigid member |
| 302 | Container System |
| 304 | Flexible container |
| 310 | Connection elements |
| 320 | Closure system |
| 342 | Closed state |
| 344 | Open state |
| 350 | Bicycle |
| 402A | First container system |
| 402B | Second container system |
| 404 | Flexible container |
| 410A | Connection elements of first container system |
| 410B | Connection elements of second container system |
| 420 | Closure system |
| 442 | Closed state |
| 444 | Open state |
| 450 | Bicycle |

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

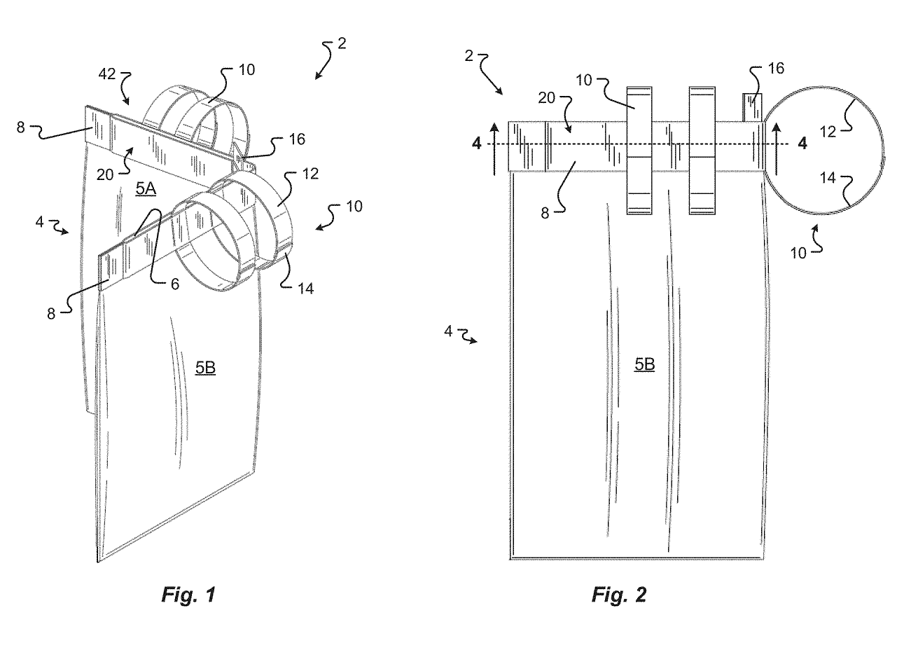

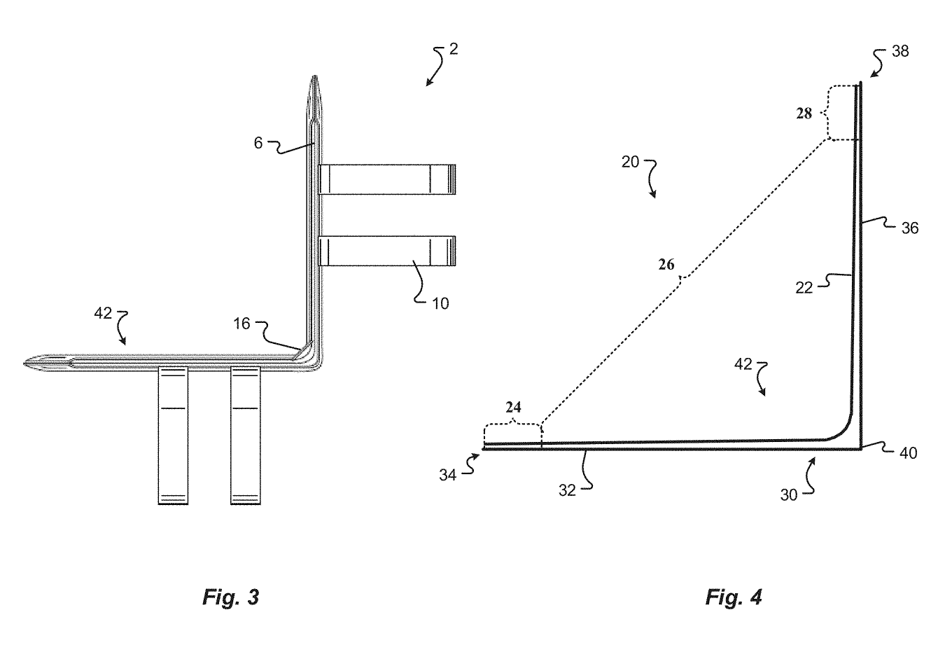

Referring now to FIGS. 1-6, a container system 2 including a flexible container 4 and a closure system 20 of an embodiment of the present disclosure is illustrated. The container system 2 generally includes the flexible container 4 with an aperture 6, connection elements 10, and an actuation member 16. A hem 8 may be formed proximate to the aperture 6. The actuation member 16 may comprise a tab or a handle sized to be grasped and pulled. In one embodiment, the actuation member 16 is interconnected to the flexible container 4 proximate to a medial portion of the closure system 20. Accordingly, when the container system 2 is interconnected to an object using connection element 10, the container aperture 6 may be opened with one hand by pulling the actuation member 16 outwardly.

The connection elements 10 are adapted to interconnect the container system 2 to an object. The elements 10 may comprise a first portion 12 selectively secured to a second portion 14. The first and second portions 12, 14 may comprise a hook and loop material. Alternatively, the first and second portions 12, 14 may comprise snaps or cords that may be tied together. In one embodiment, the connection elements 10 comprise loops. In one embodiment, the connection elements 10 are adapted to interconnect the container system 2 to the handlebars of a bicycle. However, it will be appreciated that the container system 2 may be adapted to be interconnected to any desired object.

The flexible container 4 may be of any size, shape, and color. In one embodiment, the flexible container is made of one or more materials including fabric, leather, plastic, and paper. In one embodiment, the flexible container 4 is a bag. In one embodiment, the container comprises a first portion 5A interconnected to a second portion 5B. Optionally, the portions 5A, 5B are interconnected along three of their four adjoining edges with the unconnected edge forming the container aperture 6. The portions 5A, 5B may be interconnected by any method known to one of skill in the art including, but not limited to, sewing, welding, riveting, stapling, and gluing. Alternatively, in another embodiment, the container 4 comprises one piece of material folded such that portions 5A, 5B are in an opposing alignment. Two of the three adjoining edges are subsequently interconnected leaving third adjoining edges unconnected to form the container aperture 6.

The closure system 20 is interconnected to the container 4 proximate to the aperture 6. In one embodiment, the closure system 20 is positioned within the hem 8. However, other locations of the closure system 20 are contemplated.

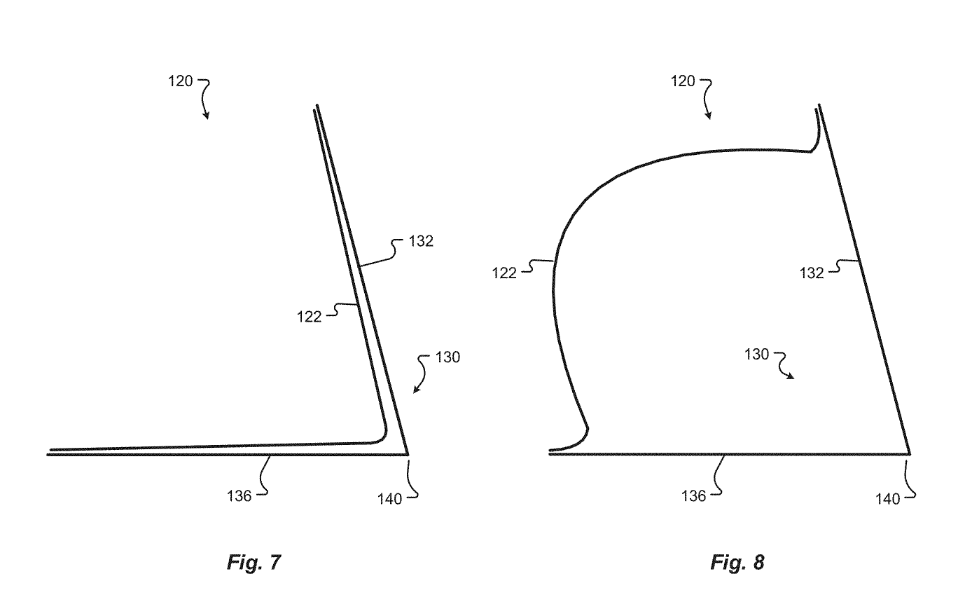

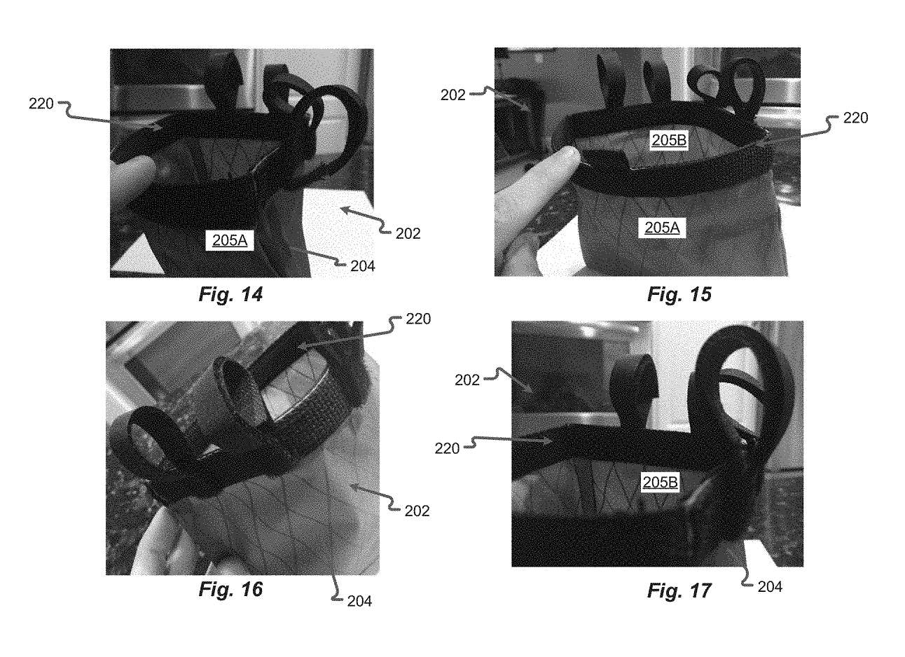

Referring now to FIGS. 4 and 6, the closure system 20 generally comprises a flexible member 22 and a substantially rigid member 30. When the closure system 20 is in the closed state 42, illustrated in FIG. 4, the flexible member 22 is positioned proximate to the rigid member 30. It follows that when the closure system 20 is in the open state 44, illustrated in FIG. 6, the flexible member 22 is positioned generally distal from the rigid member 30.

The substantially rigid member 30 may be of any suitable size and cross-section. The rigid member 30 has a compound shape. In one embodiment, the rigid member comprises a first portion 32 interconnected at a vertex 40 to a second portion 36. The first and second portions 32, 36 are generally linear.

The angle between the first and second portions 32, 36 may be adjusted based on the object to which the container system 2 will be interconnected. In one embodiment, the angle between the first and second portions 32, 36 is between about 5° to about 175°. In another embodiment, the angle between the first and second portions 32, 36 is between about 70° and about 110°. Optionally, in one preferred embodiment, the angle is between about 85° and about 95°. In a more preferred embodiment, illustrated in FIGS. 4 and 6, the angle is about 90°.

The first and second portions 32, 36 may be integrally formed in one piece or separately formed. Accordingly, in one embodiment, the first and second portions 32, 36 are adjustably interconnected so that the angle between the first and second portions 32, 36 may be adjusted by a user. For example, the first and second portions 32, 36 may be interconnected by a threaded fastener such as, but not limited to, a bolt or a screw. Accordingly, the user may loosen the threaded fastener to adjust the angle between the first and second portions 32, 36.

The rigid member 30 may be made of any suitable material. In one embodiment, the substantially rigid member comprises one or more of metal, wood, plastic, and combinations thereof. In another embodiment, the substantially rigid member is made of a laminate material comprising one or more layers of at least one of metal, wood, and plastic. The layers may be of different widths and thicknesses. In one embodiment, the cross-section of the substantially rigid member 30 provides some, or all, of the rigidity. In another embodiment, the material of the substantially rigid member 30 provides some, or all, of the rigidity.

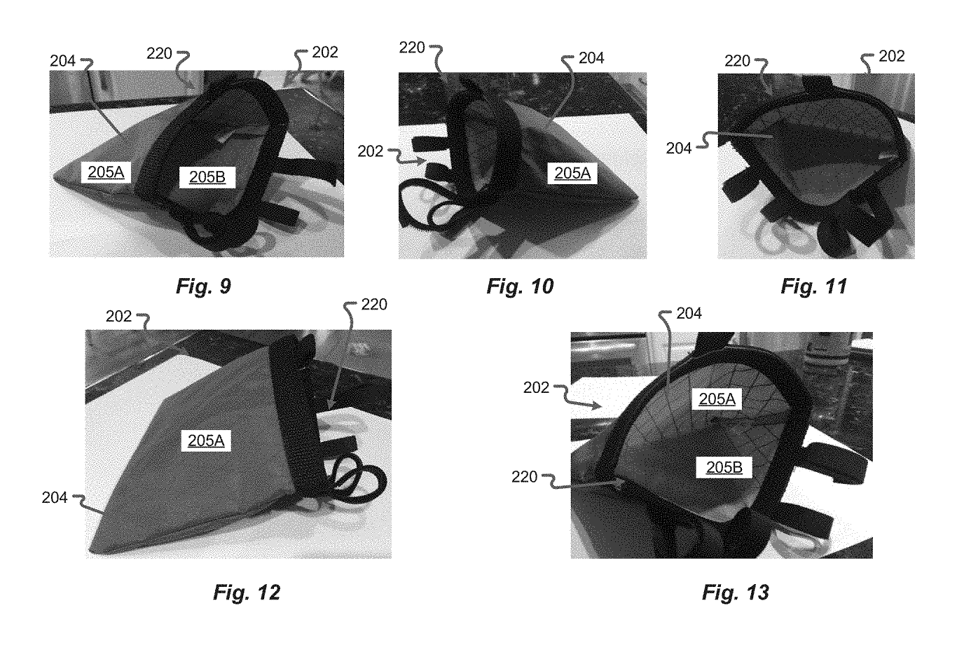

The flexible member 22 has a length greater than a linear distance between the ends 34, 38 of the substantially rigid member 30. In this manner, the flexible member 22 is adapted to bend when the closure system 20 is in the closed state 42 such that the flexible member 22 is generally proximate to the rigid member 30, as illustrated in FIG. 4. When the closure system 20 is in the open state 44, the flexible member 22 bends away from the rigid member 30 into a bowed or arcuate shape, illustrated in FIG. 6. Accordingly, referring now to FIG. 5, the aperture 6 of the container 4 has a generally arcuate or bowed shape when the closure system 20 is in the open state 44.

The flexible member 22 may be made of any suitable resilient material or combination of resilient materials. In one embodiment, the flexible member 22 is made from a plastic material, but other materials with suitable resilient properties may be used. For example, the flexible member 22 may be made of a plastic, a metal, a wood, or any combination thereof. In another embodiment, the flexible member 22 comprises a material that has shape memory. Accordingly, the flexible member 22 will return to a first configuration when a force applied to the closure system 20 is removed. In still another embodiment, the flexible member 22 includes Nitinol. In one embodiment, the flexible member 22 comprises a laminate material with a plurality of layers that may include at least one of a plastic, a metal, and a wood. The layers may be of different sizes and thicknesses and have different bending stiffnesses. As will be apparent to one of skill in the art, the selection of materials to form the layers composing flexible member 22 may be selected to impart more rigidity or more flexibility to the flexible member 22, thereby making the closure system 20 more difficult (or easier) to open and close, respectively.

Optionally, the flexible member 22 may comprise one or more portions. Referring again to FIGS. 4 and 6, the flexible member 22 may comprise a first portion 24 proximate to the first end 34 of the rigid member 30, a medial second portion 26, and a third portion 28 proximate to the second end 38 of the rigid member 30. In one embodiment, the first and third portions 24, 28 of the flexible member 22 are interconnected to corresponding first and second portions 32, 36 of the substantially rigid member 30.

The first, second, and third portions 24, 26, 28 may be made of the same or different materials. Similarly, the portions 24, 26, 28 may be made of different numbers of layers of materials, the layers may be arranged differently, and/or the layers may be of different dimensions.

Further, the bending stiffness and/or the elastic modulus of the first and third portions 24, 28 may be the same or similar. Optionally, the bending stiffness and/or the elastic modulus of the second portion 26 is different than at least one of the first and third portions 24, 28.

The flexible member 22 may have any suitable cross-sectional shape. As can be appreciated by a skilled person in the art, the flexible member 22 may have a substantially planar cross-section. However, other shapes that are not planar are contemplated. For example, in one embodiment the flexible member may have a generally circular cross-section. Similarly, the cross-sectional shape may vary along a length of the flexible member. Thus, the cross-sectional shape may change to alter the bending stiffness and/or the elastic modulus of selected portions of the flexible member 22. Accordingly, a cross-sectional shape of the flexible member 22 proximate to the first and third portions 24, 28 may optionally be different than the cross-sectional shape of the flexible member 22 proximate to the second portion 26.

Additionally, the dimensions of the flexible member 22 may vary along the length of the flexible member to adjust the bending stiffness and/or the elastic modulus. Accordingly, the flexible member 22 may have a first size proximate to the first and third portions 24, 28 and a different second size proximate to the second portion 26.

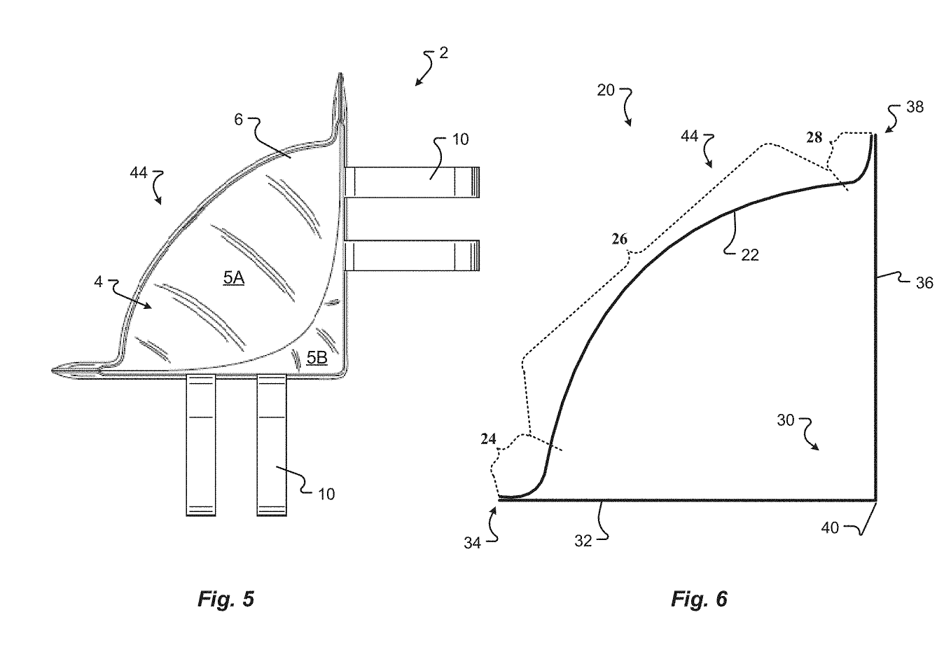

The closure system 20 remains in the closed state 42 until an opening force is applied to the flexible member 22. More specifically, when the closure system 20 is in the closed state 42 as illustrated in FIG. 3, an opening force may be applied to the flexible member 22 to pull the flexible member 22 away from the substantially rigid member 30 to transition the closure system 20 to the open state 44 illustrated in FIG. 5. In one embodiment, the opening force may be applied by pulling the actuation member 16 away from the substantially rigid member 30.

Similarly, the closure system 20 remains in the open state 44 until a closing force is applied to the flexible member 22. The closing force is applied in a direction toward the substantially rigid member 30. In one embodiment, the closing force may be applied to the flexible member 22 proximate to, but not necessarily on, the actuation member 16.

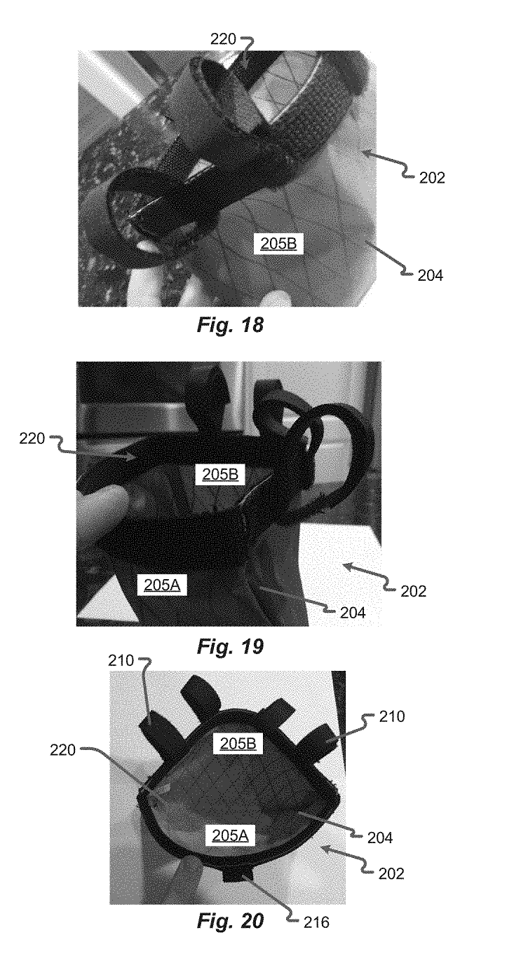

Referring now to FIGS. 7-8, a closure system 120 of another embodiment of the present disclosure is illustrated. The closure system 120 generally includes a flexible member 122 and a substantially rigid member 130 that are the same as, or similar to, members 22, 30 described above. However, the first and second portions 132, 136 of the rigid member 130 are not orthogonal. In one embodiment, the first and second portions 132, 136 form an angle of between about 61° and about 89° with respect to a vertex 140. More preferably, the angle between the first and second portions 132, 136 is between about 70° and about 80°.

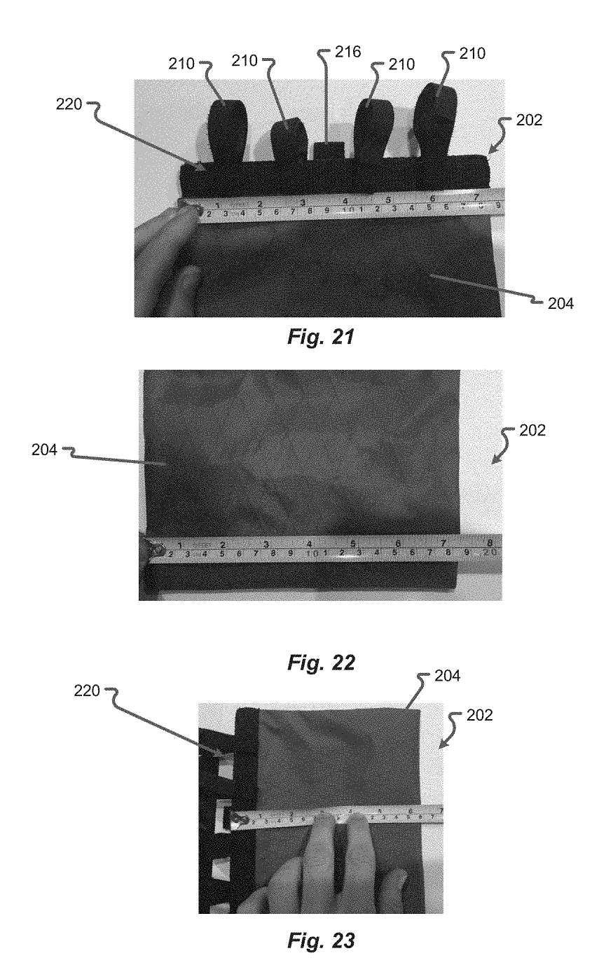

Referring now to FIGS. 9-26, a variety of photographs illustrate features of a container system 202 with a flexible container 204 and a closure system 220 of another embodiment of the present disclosure. The container system 202 and closure system 220 may be the same as, or similar to container systems 2, 102, and closure systems 20, 120 described above. Further, as illustrated in FIG. 20, the container system 202 may optionally include connection elements 210 and an actuation member 216 the same as, or similar to, the connection elements 10 and actuation member 16 of container system 2.

As previously described, the container 204 may have any desired shape and dimension. Referring now to FIGS. 21-22, in one embodiment, the container 204 has a width of about 7.25 inches. Referring now to FIG. 23, in one embodiment, the container 204 has a height of about 6.25 inches. Referring now to FIG. 24, a distance between the ends 234, 238 of the substantially rigid member 230 is about 6 inches. When the closure system 220 is in an open state, illustrated in FIGS. 25-26, the container aperture 206 has a width of about 4.25 inches from the vertex of the rigid member 230 to a portion of the flexible member 222.

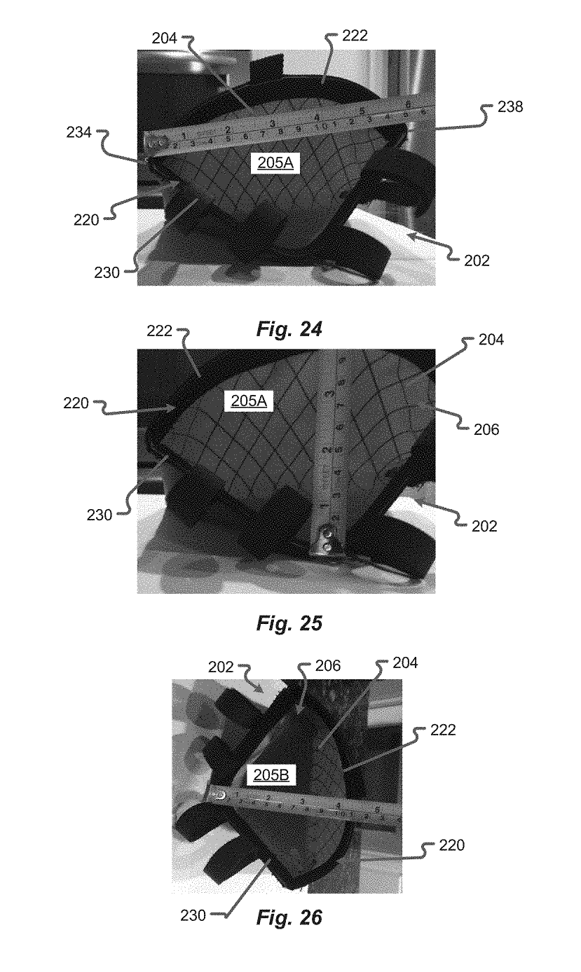

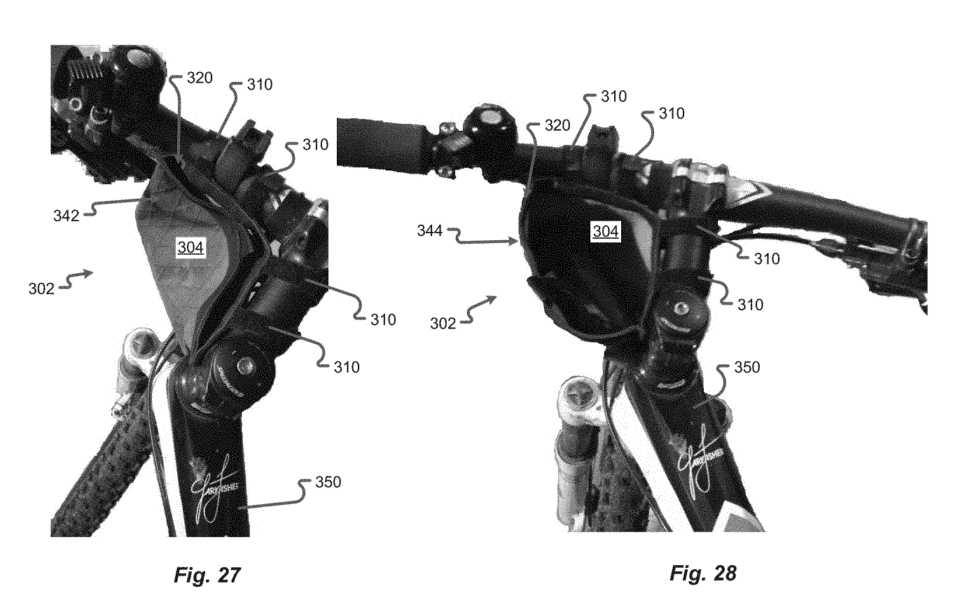

Referring now to FIGS. 27-28, photographs of still another embodiment of a container system 302 including a flexible container 304 and closure system 320 of the present disclosure are provided. The container system 302 is illustrated releasably interconnected to the handlebars of a bicycle 350 using connection elements 310 of the container system 302. The container system 302 and closure system 320 may be the same as, or similar to, containers 2, 102, 202 and systems 20, 120, 220 described above. It will be appreciated that the container system 302 may be interconnected to other objects or to different portions of the bicycle 350.

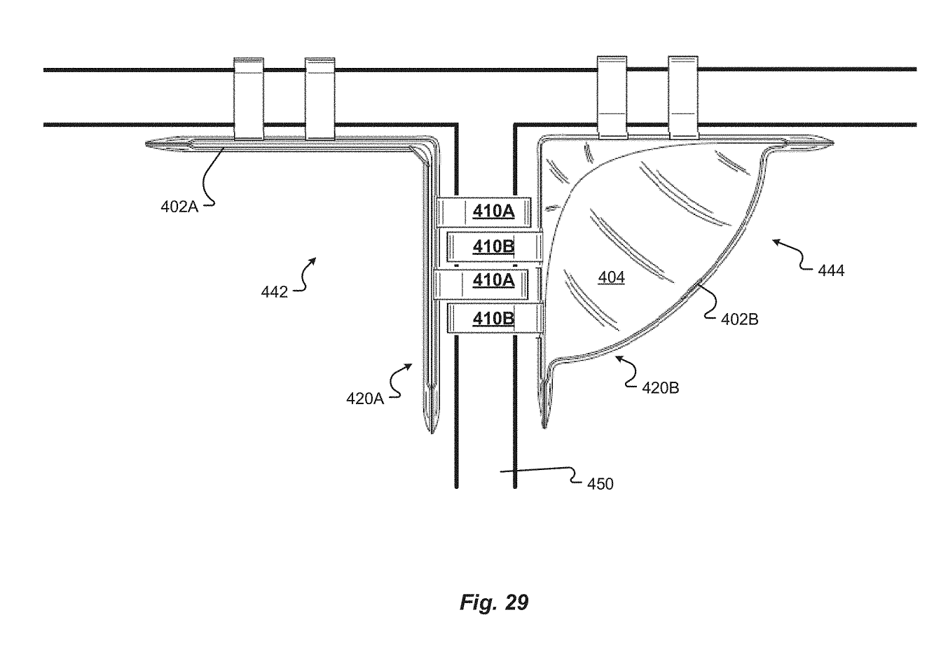

Referring now to FIG. 29, container systems 402A, 402B of still another embodiment of the present disclosure are illustrated releasably interconnected to the handlebars of a bicycle 450. The containers systems 402A, 402B each include a flexible container 404 and a closure system 420. Each container system 402A, 402B also includes connection members 410 to selectively interconnect the container systems to the bicycle. The connection members 410A of container system 402A are positioned in a staggered arrangement with respect to the connection members 410B of container system 402B. In this manner, the connection members 410A do not interfere with the connection members 410B. Other arrangements of the connection members 410A, 410B are contemplated.

While various embodiments of the present disclosure have been described in detail, it is apparent that modifications and alterations of those embodiments will occur to those skilled in the art. It is to be expressly understood that such modifications and alterations are within the scope and spirit of the present disclosure. Further, the present disclosure is capable of other embodiments and of being practiced or of being carried out in various ways.

What is claimed is:

1. A closure system for a flexible container, comprising:
a flexible member interconnected to a first portion of the flexible container proximate to an aperture of the flexible container; and
a substantially rigid member interconnected to a second portion of the flexible container proximate to the aperture, the second portion arranged in a substantially opposing alignment with the first portion, wherein, when the closure system is in a closed state, the flexible member is in a position proximate to the substantially rigid member and, when the closure system is in an open state, at least a medial portion of the flexible member is distal to the substantially rigid member.

2. The closure system of claim 1, wherein the closure system remains in the open state without contact from the user.

3. The closure system of claim 1, wherein the substantially rigid member comprises a first portion interconnected at a vertex to a second portion.

4. The closure system of claim 3, wherein an angle between the first and second portions of the substantially rigid member is between about 70° and about 110°.

5. The closure system of claim 3, wherein the first and second portions of the substantially rigid member are pivotally interconnected such that an angle between the first and second portions may be adjusted to be between about 70° and about 110°.

6. The closure system of claim 3, wherein:
the first portion of the substantially rigid member is interconnected to a first portion of the flexible member; and
the second portion of the substantially rigid member is interconnected to a second portion of the flexible member.

7. The closure system of claim 1, wherein the substantially rigid member comprises at least one of a metal, a wood, a plastic, and combinations thereof.

8. The closure system of claim 1, wherein the substantially rigid member comprises a laminate material comprising one or more layers of at least one of a metal, a wood, and a plastic.

9. The closure system of claim 1, wherein the flexible container further comprising at least two connection elements to releasably interconnect the flexible container to an object.

10. The closure system of claim 1, wherein the flexible member has a length that is greater than a distance between a first end and a second end of the substantially rigid member.

11. The closure system of claim 1, wherein:
the flexible container has a width of between about 5 inches and about 9.5 inches; and
the flexible container has a height of between about 4 inches and about 8.5 inches.

12. The closure system of claim 11, wherein, when the closure system is in an open state, the container aperture has a width of between about 2 inches and about 6.5 inches.

13. A container with an aperture configured to remain in an open configuration without contact from a user, comprising:
a body portion with the aperture;
a flexible member interconnected to a first portion of the body portion;
an actuation member interconnected to the first portion of the body portion;
a substantially rigid member interconnected to a second portion of the body portion; and
at least two connection elements interconnected to the second portion of the body portion, wherein, when the flexible member is proximate to the substantially rigid member the aperture is in a closed configuration, and wherein, in the open configuration, at least a portion of the flexible member is separated from the rigid member.

14. The container of claim 13, wherein pulling on the actuation member transitions the aperture from the closed configuration to the open configuration.

15. The container of claim 14, wherein a force must be applied to the first portion in a direction toward the second portion to transition the aperture from the open configuration to the closed configuration.

16. The container of claim 13, wherein the substantially rigid member comprises a first portion interconnected to a second portion.

17. The container of claim 16, wherein an angle between the first and second portions of the substantially rigid member is between about 70° and about 110°.

18. The container of claim 16, wherein the first and second portions of the substantially rigid member are pivotally interconnected such that an angle between the first and second portions may be adjusted to be between about 70° and about 110°.

19. The container of claim 13, wherein the at least two connection elements are adapted to interconnect the container to a portion of a bicycle.

20. A method of making a container with an aperture configured to remain in an open configuration without contact from a user, comprising:
interconnecting a flexible member to a first portion of a flexible body of the container;
interconnecting a substantially rigid member to a second portion of the flexible body, wherein the second portion is in an opposing relationship to the first portion;
interconnecting at least two connection elements to the second portion of the flexible body, the at least two connection to releasably interconnect the container to a bicycle;
interconnecting an actuation member to the first portion of the flexible body, wherein pulling on the actuation member transitions the aperture from the closed configuration to the open configuration.
